(19) United States
(12) Patent Application Publication
(10) Pub. No.: US 2019/0221096 A1
(43) Pub. Date: Jul. 18, 2019

(54) SECURITY SYSTEM WITH OCCUPANCY DETERMINATION BASED ON HVAC APPLICATIONS

(71) Applicant: CARRIER CORPORATION, Palm Beach Gardens, FL (US)

(72) Inventor: David Mannfeld, Carmel, IN (US)

(21) Appl. No.: 16/195,203

(22) Filed: Nov. 19, 2018

Related U.S. Application Data
(60) Provisional application No. 62/585,613, filed on Nov. 14, 2017.

(51) Int. Cl. G08B 19/00

(52) U.S. Cl. CPC G08B 19/005; H04L 67/10

(57) ABSTRACT

A method of applying information from a heating ventilation and air conditioning (HVAC) system in a premises to a fire and security system in the premises. The method includes acquiring information related to the operation of the HVAC system, communicating the information to the fire and security system building system, and utilizing the information in the fire and security system to arm the fire and security system, or provide a notification to a user, on a user device, of the fire and security system if the fire and security system indicates a condition not in accordance with the information, and generate an alarm, of the fire and security system, if the fire and security system indicates a condition not in accordance with the information.

### CROSS-REFERENCE TO RELATED APPLICATIONS

This application claims the benefit of 62/585,613 filed Nov. 14, 2017, which is incorporated herein by reference in its entirety.

### FIELD OF INVENTION

Embodiments relate generally to a security or access control system employing heating ventilation and cooling (HVAC) system sensors and applications. More particularly, employing sensor information, user preferences, and settings from an HVAC system, for determining occupancy and control of the security system or access control system.

### DESCRIPTION OF RELATED ART

Modem structures, such as office buildings and residences, utilize heating, ventilation, and cooling (HVAC) systems having controllers that allow users to control the environmental conditions within these structures. These controllers have evolved over time from simple temperature based controllers to more advanced programmable controllers, which allow users to program a schedule of temperature set points in one or more environmental control zones for a fixed number of time periods as well as to control the humidity in the control zones, or other similar conditions. Such structures may also have access control and security systems that employ a credential such a password, card, ID badge, or mobile device running an application to permit a user to access or control various areas in the structure. Users may also employ an app that facilitates access to their home. Some of these apps may include a security system or a home HVAC systems. Users commonly can configure their home systems with a variety of preferences and selections. However in many instances the functionality of the security system remains for the most part independent of the HVAC system. In addition, the apps employed for each of the systems also remains substantially independent. Excessive programming is burdensome on the user and may result in disinterest or users not taking advantages of the features and benefits a building system may provide. Moreover, lack of integration between systems limits functionality and may degrade performance. Therefore, having a building system, in particular a security system that can utilize and take advantage of sensors and a user's preprogrammed preferences from HVAC applications in security and access control applications is highly desirable and would provide improved functionality.

### BRIEF SUMMARY

Described herein in an embodiment is a method of applying information from a heating ventilation and air conditioning (HVAC) system in a premise to a fire and security system in the premise. The method includes acquiring information related to the operation of the HVAC system, communicating the information to the fire and security system building system, and utilizing the information in the fire and security system to arm the fire and security system, or provide a notification to a user on a user device of the fire and security system if the fire and security system indicates a condition not in accordance with the information, and generate an alarm of the fire and security system if the fire and security system indicates a condition not in accordance with the information.

Also described herein in an embodiment is a system for applying information from a heating ventilation and air conditioning (HVAC) system in a premises to a fire and security system in the premises. The system includes an HVAC system configured to control the environment of a premises, the HVAC system having a controller; and a fire and security system configured to monitor the access to a premises, the fire and security system having a controller and a sensor for monitoring activity at the premises. The controller is configured to acquire information related to the operation of the HVAC system, and use the information in the fire and security system to arm the fire and security system, provide a notification to a user on a user device of the fire and security system if the fire and security system indicates a condition not in accordance with the information, or generate an alarm of the fire and security system if the fire and security system indicates a condition not in accordance with the information.

In addition to one or more of the features described above, or as an alternative, further embodiments may include that the acquiring includes the fire and security system communicating to at least one of a sensor in the HVAC system, a cloud computing environment, the user device, and a control device associated with the HVAC system.

In addition to one or more of the features described above, or as an alternative, further embodiments may include that the information includes at least one of: HVAC system sensor information, a user setting or preference, a schedule, and an operational parameter of the HVAC system.

In addition to one or more of the features described above, or as an alternative, further embodiments may include that the information is inferred from the at least one of a user setting or preference, a schedule, and an operational parameter of the HVAC system.

In addition to one or more of the features described above, or as an alternative, further embodiments may include that the information inferred is the occupancy of the premises based on programming of the HVAC system as “away” from the premises.

In addition to one or more of the features described above, or as an alternative, further embodiments may include that the HVAC system and the fire and security system are separate stand-alone systems.

In addition to one or more of the features described above, or as an alternative, further embodiments may include that the information is used as one of a replacement for sensor information of the fire and security system or in addition to sensor information of the fire and security system.

In addition to one or more of the features described above, or as an alternative, further embodiments may include that the information is occupancy of the premises.

In addition to one or more of the features described above, or as an alternative, further embodiments may include that the information is occupancy and the utilizing is in lieu of a sensor in the fire and security system.

In addition to one or more of the features described above, or as an alternative, further embodiments may include determining if a user device is not connected or within a selected range of the premises to facilitate the using the information.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded of the described embodiments is particularly pointed out and distinctly claimed in the claims at the conclusion of the specification. The foregoing and other features, and advantages of the described embodiments are apparent from the following detailed description taken in conjunction with the accompanying drawings in which

FIG. 1 depicts a simplified diagrammatic view of a fire and security system in accordance with an embodiment;

FIG. 2 is a depiction of a HVAC system as may be employed in accordance with an embodiment;

FIG. 3 depicts a high level diagrammatic view of a fire and security system and HVAC system and the interfaces for implementing the methodology of applying information from a heating ventilation and air conditioning (HVAC) system in a premises to a fire and security system in the premises in accordance with an embodiment; and

FIG. 4 depicts a flowchart of an example method of applying information from a heating ventilation and air conditioning (HVAC) system in a premises to a fire and security system in the premises in accordance with an embodiment.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in Figure X may be labeled “Xa” and a similar feature in Figure Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Embodiments related to a method of applying sensor information, and user scheduling and preferences from a user's HVAC system as an additional, backup or replacement input for an access control and/or security system. More particularly, employing the sensors and settings for determining or inferring occupancy associated with the operation of the HVAC system to provide a determination of occupancy of the building space e.g., a user's home.

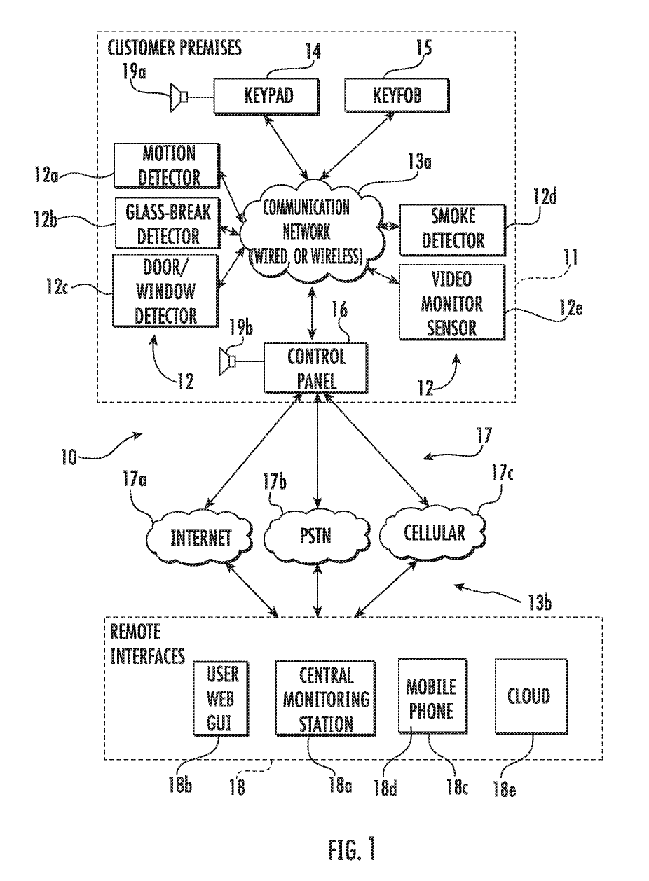

FIG. 1 illustrates a fire and security system 10, which is located on premises 11 and which includes a plurality of sensors 12 such as motion detector 12a, glass-break detector 12b, door or window contact sensor 12c, smoke detector 12d, and video monitor 12e. A communication network 13a, which is wired or wireless, connects the sensors 12 to control panel 16. Keypad 14 and key fob 15 are examples of devices which allow the user to control and activate or deactivate the fire and security system 10. Keypad 14 can be wireless or hardwired. In some embodiments, keypad 14 is also used as a registration module and carried from one sensor to another during the registration process. In some embodiments, the keypad 14 and the control panel 16 are integrated. Control panel 16 located on premises 11 sends signals via communication networks 17 including, but not limited to: internet.WiFi® 17a, land line 17b or cellular network 17c, to a remote interfaces 18 for reception by central monitoring station 18a, user web interface 18b, or mobile phone 18c. It will be appreciated that while internet connection 17a, phone land lines 17b, and cellular 17c communications are shown, numerous other communication interfaces may be employed as described further herein.

Mobile phone 18c may be employed to interface with the fire and security system 10. In an embodiment mobile phone 18c can be any user device that facilitates access and control with the system 10, e.g., a mobile device, tablet, PDA, and the like. Mobile phone 18c executes an app 18d that is operable on the mobile device 18c (or a web based application 18b), that permits and facilitates the user to enter and receive information and for remote device 18, or mobile phone 18c to communicate with and control the fire and security system 10. In an embodiment, the app 18b, 18d may be employed by the user to set operating parameters, set points (e.g., temperature settings schedules), and the like for the fire and security system 10.

In addition, some, or all of the functionality provided to control the building system (e.g. fire and security system 10) may be based on methods and processes executed remotely such as on a local or remote server or cloud computing environment 18e. As will be appreciated, cloud computing environment 18e could include a local or remote server, or the system could be entirely remote. In this example, the fire and security system 10 may also include a local and remote communication network 13a, 13b whether wired or wireless and the like.

During the use of fire, security and access control system 10, when a change occurs in a condition being monitored, sensor 12 associated with that condition sends a signal to control panel 16 which then determines how to respond to the sensor input. For example, the control panel, based on its operational programming, may indicate a new operational status of the system 10; provide a notification to devices such as keypad 14 on the premises and/or to remote central monitoring station 18a as well as to a user on their mobile device 18c. If, for example, the notification (indicating an intrusion or fire) is generated, the notification is then relayed to assist first responders such as firefighters and security personnel to locate the sensor 12 and address the change in condition. The notification may include a voice tag such as a pre-recorded portion related to the specific type of sensor 12 and a second portion related to the location of that sensor 12 as may have been previously recorded. The notification may also be an alarm to provide a warning to occupants of the premises 11. This announcement is made via speakers 19a and 19b. In an embodiment, determinations of how to respond to various sensor signals may be made by the control panel 16 based on numerous factors associated with the operation of the system 10, for example, whether the premises 11 is currently occupied. Therefore determining whether the premises 11 is occupied is important to not only proper operation of the system 10 but also how the system operates. For example, if a sensor 12 indicates a glass breakage (e.g., 12b), the control panel 16 may elect to provide a notification to the user via their mobile device 18c first, rather than sound an alarm based on whether the sensor 12 indicated that the premises 11 was occupied or not. Likewise, if a sensor 12 indicates that a door (e.g., door sensor 12c) has been opened, it may be desirable to transmit video data form the video sensor 12e to the user for evaluation and dispositioning.

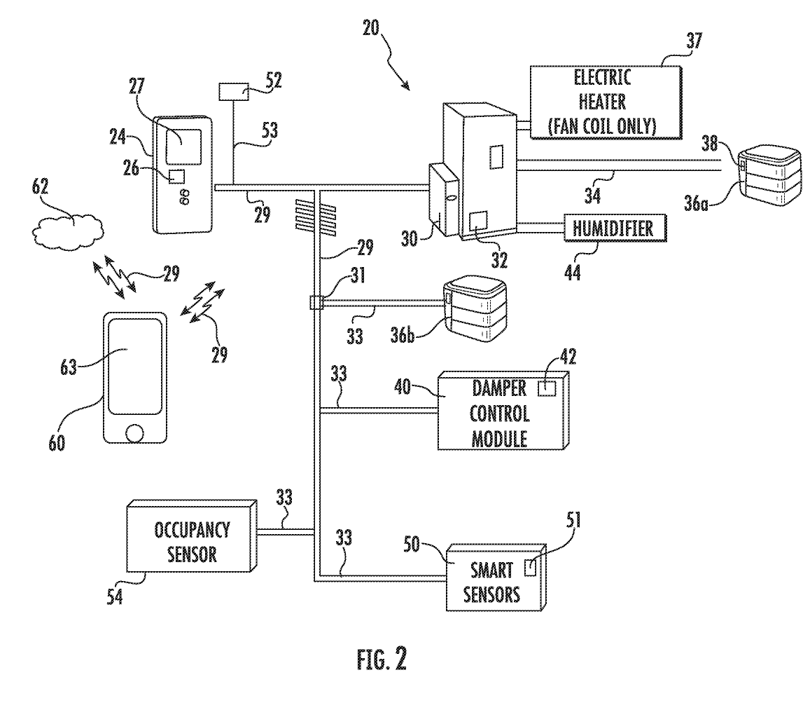

FIG. 2 is a simplified illustration of a basic HVAC system 20 incorporating a thermostat or controller 24 having user input settings as is conventionally known for scheduling and operation. The controller 24 include a microprocessor 26, memory, and communication module(s), as needed to facilitate operation and interfacing with various components and elements of the HVAC system 20. The processor 26 can be any type or combination of computer processors, such as a microprocessor, microcontroller, digital signal processor, application specific integrated circuit, programmable logic device, and/or field programmable gate array. For example, the controller 24 may include a computer program stored on nonvolatile memory to execute instructions via the microprocessor 26 related to aspects of communicating and controlling the HVAC 20, and in particular executing a method for utilizing HVAC occupancy information as described further herein.

As is conventionally done, the processor 26 is coupled to system memory, the memory can be a non-transitory computer readable storage medium tangibly embodied and including a program comprising executable instructions stored therein, for instance, as firmware. Communication interfaces are employed to interface with mass storage e.g., hard disk, solid state storage, or any other similar component. The communication interfaces also interface the processor 26 to communication networks 29 enabling the controller 24 to communicate with other components in the HVAC system 20 as well as other systems such as fire and security and access control system 10. The communication interfaces and network may implement one or more communication protocols as described in further detail herein. The controller 24 may further include a user interface 27 (shown in FIG. 2, e.g., a display screen, a microphone, speakers, input elements such as a keypad or touch screen, etc. as known in the art). Features and functions as described may be omitted, integrated, or distributed as desired and as required to suit a particular application.

In an embodiment, the microprocessor 26 controls communication and issues commands to and between the various units of the HVAC system 20. Microprocessor when executing an operation program for the HVAC system 20 makes various command and control decisions based upon user settings, sensor inputs, as well as other data provided by the respective components of the HVAC system 20, as in conventionally known. The communication interface 29 is depicted as a wired data bus, but it could be wired or wireless and implemented with one or more known protocols. Communication interface 29 is employed to communicate between the microprocessor 26 of the controller 24 and a microprocessor 32 at an indoor unit 30, such as a furnace control, or a fan/heater control. As shown, other peripheral units may communicate through the microprocessor 32 at indoor unit 30 and back to the microprocessor 26 at thermostat 24. An example of a peripheral unit would be a humidifier 44, which may not have its own microprocessor control. The humidifier 44 is shown as an existing type peripheral that could be hard-wired to communicate with the microprocessor 32, and then to microprocessor 26, over data bus 29. Microprocessor 26, in turn, provides control signals back to the humidifier 44 to facilitate controlling the environment of the building. Alternatively, in HVAC systems generally, humidifiers and other components may be controlled over the same data bus 29 incorporated into the system 20. Again, the microprocessor 26 would then be fully functional to control that new microprocessor at the humidifier 44. Likewise, a damper control module 40 having a microprocessor 42 is shown communicating with the data bus 29, and then to microprocessor 26 through bus interface, such as at a routing or junction box 31. In one configuration, another communication interface 34 interfaces microprocessor 32 to an outdoor unit 36(a), and its microprocessor 38. As mentioned above, the microprocessor 32 at the indoor unit 30 is also capable of controlling a hard-wired outdoor unit 36b.

When a user inputs desired environmental conditions into the controls 24 at the thermostat 24, the microprocessor 26 sends appropriate control signals over the data bus 29 to the indoor unit 30, and “peripherals” (i.e., damper control 40). From indoor unit 30, the signal may be sent to outdoor unit 36a, and “peripheral” 44. Thermostat 24 communicates with the indoor unit 30 over the data bus 29. An electric heater 37 may be hard wired to the indoor unit 30 that if the indoor unit 30 is a fan coil and control. The fan coil control 32 is operable to control the electric heater 37. Indoor unit 30 could also be a furnace, for example a gas furnace.

Also, the controller 24 (e.g., thermostat) may be provided with a variety of sensors 50, 52, 54, for example a room temperature sensor 52, and optionally may be provided with a humidity sensor, occupancy sensors 54 and the like. Also, among the information communicated could be identity codes such that microprocessor 26 can identify a reporting unit, status and fault information, as well as the standard feedback normally provided by such units to a system control. As can be appreciated, the signals communicated over the system 20 are provided with codes or identifiers such that they are properly routed and identified.

As shown also in FIG. 2, a remote sensor 50, 52 may communicate directly with the thermostat 24. The data bus 53 connecting this remote sensor 50, 52 to the thermostat 24 may be connected to the data bus 29 such as at a junction box, etc. Such a remote sensor 50, 52 may be utilized in the same room as the thermostat 24 when it is desired to have a temperature sensor (e.g., 52) in the room, but the thermostat 24 is concealed (e.g., such as in a closet, etc.), or for remote sensing. As another example, the outdoor unit 36b may be directly connected to data bus 29, branched through data bus 33. Appropriate junction or attachments 31 connect data bus 33 to data bus 29. Such a connection may be utilized when the outdoor unit 36b has its own microprocessor control, but for any number of reasons, it is desirable to wire the outdoor unit 36b directly into the bus 33, rather than through the indoor unit 30 (such as if the indoor and outdoor units are remote from each other within the building).

As shown, damper control module 40 has a microprocessor 42 and may provide a control function for one or more dampers in the HVAC system 20. Here again, the microprocessor 42 at the damper control module 40 is provided with control instructions for controlling the dampers. As is known, a damper control module 40 takes in control signals and opens or closes dampers to control the flow of air into various rooms within a building. Of course, damper control module 40 may be simply directly connected via data bus 33 to the data bus 29. Smart sensors 50 may include a microprocessor 51, and be connected over data bus 33 to the data bus 29. Of course, as would be understood by a worker of ordinary skill in this art, any data bus 33 could also be connected directly to the data bus 29, rather than through a junction 31.

The microprocessors e.g., 26, 32, 42 associated with each of the units are provided with built-in software to communicate back to the thermostat microprocessor 26, and to interpret and act upon instructions from microprocessor 26. In operation, controller 24 monitors various sensors to ascertain the condition of the building. When the controller 24 determines, based on the information from the sensors or user settings, that there is a call for heating/cooling in the building, signals are directed to the indoor unit 30 and/or outdoor unit 36a, 36b to provide heating or cooling. The outdoor unit 36a, 36b works in cooperation with the indoor unit 30 typically running a vapor compression cycle to facilitate providing the heating or cooling to the building space.

User device 60 may be employed to interface with the HVAC system 20. In an embodiment the user device 60 (e.g., a mobile device, mobile phone, tablet, PDA, and the like) executes an app 63 that is operable on the user device 60, that permits and facilitates the user to enter and receive information and for user device 60 to communicate with and control the HVAC system 20. In an embodiment, the app 63 may be employed by the user to set operating parameters, set points (e.g., temperature settings schedules), and the like for the HVAC system 20.

In addition, some, or all of the functionality provided to control the building system (e.g. fire and security system 10 or HVAC system 20) may be based on methods and processes executed remotely such as on a local or remote server or cloud computing environment 62.

Each of these systems 10, 20 may include one or more controllers (e.g. 16, 60) that is employed to control the system 10 and 20 and interface to the building. In addition, once again, some, or all of the functionality provided by and control the building system 10 or 20 may be based on methods and processes executed remotely such as on a local or remote server, or second cloud computing environment 18e, 62. Cloud computing is a widely adopted and evolving concept. Generally, cloud computing refers to a model for enabling ubiquitous, convenient, and on-demand access via Internet (e.g., 17a) to shared pools of configurable computing resources such as networks, servers, storages, applications, functionalities, and the like. There are a number of benefits associated with cloud computing for both the providers of the computing resources and their customers. For example, customers may develop and deploy various business applications on a cloud infrastructure supplied by a cloud provider without the cost and complexity to procure and manage the hardware and software necessary to execute the applications. The customers do not need to manage or control the underlying cloud infrastructure, e.g., including network, servers, operating systems, storage, etc., but still have control over the deployed applications. On the other hand, the provider's computing resources are available to provide multiple customers with different physical and virtual resources dynamically assigned and reassigned according to clients' load. Further, cloud resources and applications are accessible via the Internet (e.g., 17a).

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

A cloud computing environment is service oriented with a focus on statelessness, low coupling, modularity, and semantic interoperability. At the heart of cloud computing is an infrastructure comprising a network of interconnected nodes. Cloud computing nodes may communicate with one another and/or be grouped (not shown) physically or virtually, in one or more networks, such as Private, Community, Public, or Hybrid clouds, or in one or more combinations thereof. This allows cloud computing environment to offer infrastructure, platforms and/or software as services for which a cloud consumer does not need to maintain or minimize resources at a local computing device level. It is understood that the types of computing devices 14 and controllers such as control panel 16, GUI 18b, mobile device 18c or controller 60 (FIG. 2) are all configured to interface if desired with a cloud computing environment 18e, 62 (as shown in FIG. 2). It should also be appreciated that cloud computing environment 18e, 62 can communicate with any type of computerized device over any type of network and/or network addressable connection (e.g., using a web browser, app, and the like). It should also be appreciated that the user device 60 or mobile device 18c may be any form of a mobile device (e.g., smart phone, smart watch, wearable technology, laptop, tablet, etc.). It should be appreciated that the system controllers 16, 24 are typically part of the installed building system infrastructure, while the mobile phone 18c, or user device 60 is typically owned and used by the user, service man, homeowner, and the like. The term “user device” is used to denote all of these types of devices as may be employed by the user for the purposes of communication with the building system(s) 10, 20. It should be appreciated that in some instances a user device 60/mobile phone 18c or the controllers 16, 24 are proximate to the systems 10, 20, respectively. For example, a thermostat, control panel, or system control unit, in others they are mobile for example, a car, PDA, or movable kiosk. The user devices (e.g., mobile phone 18c, or 60) may also be configured to communicate with each other or a variety of sensors and systems. The communication with other devices or sensors could be wired or wireless as needed. Communication networks/interfaces (e.g., 13a, 13b, 29 (FIG. 2)), could be any variety of communication network such as local area network (LAN), wide area network (WAN) or cellular, and the like, to facilitate communication with and between devices. Other examples include Wi-Fi, short-range radio (e.g., Bluetooth®), near-field infrared, cellular network, etc. In some embodiments, controllers 16, 24 may include, or be associated with (e.g., communicatively coupled to) one or more other networked building elements (not shown), such as computers, beacons, other system controllers, bridges, routers, network nodes, etc. The networked elements may also communicate directly or indirectly with the user device 18c, 60, using one or more communication protocols or standards (e.g., through the network 13, 29). For example, the networked element may communicate with the user device 60 using near-field communications (NFC) and thus enable communication between the user device 60 and HVAC system 20 control unit 24 or any other components in the system 20 when in close proximity to the user device 60 (NFC is a short range wireless protocol). Or, for example, the networked element may communicate with the user device 60 using Bluetooth and thus enable communication between the user device 60 and HVAC system 20 control unit 24 or any other components in the system 20 from a further distance.

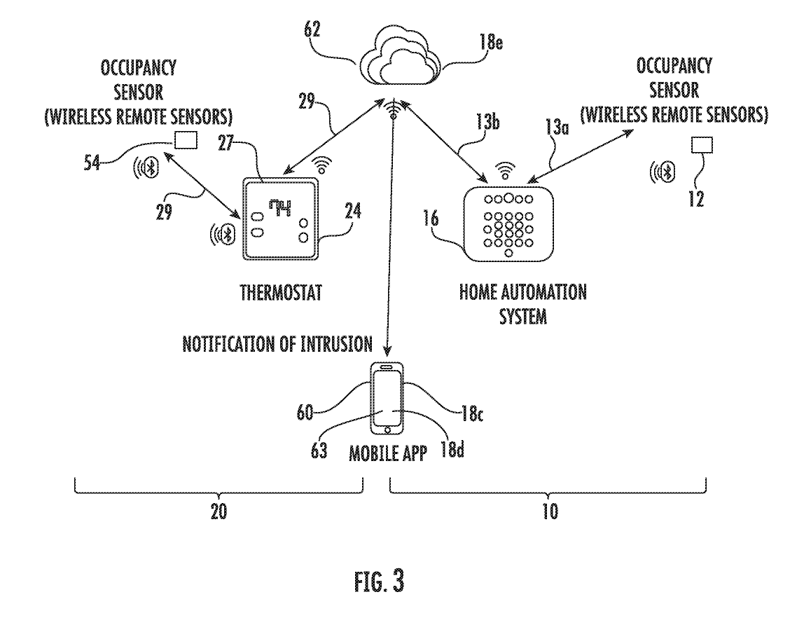

Referring now to FIG. 3 where a simplified diagram of a fire and security system 10 in communication with an HVAC system 20 in accordance with an embodiment is depicted. In an embodiment a fire and security system 10 and HVAC system 20 are integrated to at least facilitate communication between the two systems. The integration can be extensive, where both systems 10, 20 share many components and controls, or the integration could be minimal, only to the extent of facilitating communication between the two systems 10, 20. As described herein, the integration will be treated as minimal with communication of information between the two systems.

In an embodiment a portion of each of a HVAC system 20 and a fire and security system 10 are depicted with communication between the control panel 16 of the fire and security system 10 and the controller or thermostat 24 of the HVAC system 20. Controller/thermostat 20 may have occupancy sensors 54 included as part of a home HVAC system 20. Determining occupancy can assist with energy savings and setting or modifying schedules to improve system performance. In addition, alarm systems (e.g., fire and security systems 10) also have sensors 12 that detect either occupancy or intrusion. Both of these systems 10, 20 may be integrated as part of an overall home automation system via hub, cloud computing environment 18e, 62, or other communication interface. In an embodiment, this communication interface will allow communication between the thermostat 24 of the HVAC system 20 and the control panel 16 of the alarm system 10. This communication could also occur via the internet (e.g., communication network/bus 29 or 13b), including wireless communications (e.g., for example if both systems have Wi-Fi connectivity).

In an embodiment, the fire and security system 10, and the HVAC system 20 may be sufficiently coupled to integrate, share and even eliminate some sensors as redundant. For example, in an embodiment a single occupancy sensor 54 of the HVAC system 20 may be employed to make occupancy determinations for the fire and security system 10. Occupancy as detected by the sensor (12 or 54) may be transmitted by one or more of the communication interfaces 29, 17a, 17b, and the like to the HVAC system 20 and fire and security system 10. Moreover, a determination of occupancy could be made by one system (e.g., the HVAC system 20) and transmitted to the other (e.g., the fire and security system 10). In this way the fire and security system 10 can be armed as needed based on the detection of occupancy. When any occupancy is detected, then the fire and security system 10 can notify the homeowner via the mobile device 18c, authorities, and/or a central station 18a of a potential intrusion.

In another embodiment, occupancy may be inferred by the settings of the HVAC system 20, its sensor inputs or scheduling. For example, if the thermostat 24 is operating a schedule in an “away” mode, it can be inferred that the building (e.g. premises or house) is unoccupied. Under such conditions, the fire and security system 10 could be armed. When any occupancy is detected or inferred, then the fire and security system 10 can notify the homeowner via the mobile device 18c of a potential intrusion. It will be appreciated that this would provide a secondary occupancy detection technique if the primary alarm occupancy detection (e.g. sensor 12 of the fire and security system 10) has been defeated. Advantageously, such an approach provides occupancy detection capabilities of one system (e.g. HVAC system 20) acting as a back up to the to the fire and security system 10 detection.

In an embodiment, sensor information regarding occupancy may be detected from the occupancy sensor 54 of the HVAC system 20 or even inferred or determined from other measurements. In one embodiment, occupancy may be inferred by the settings of the HVAC system 20, its sensor inputs or scheduling. For example, if the thermostat 24 is operating a schedule in an “away” mode, it can be inferred that the building (e.g. premises or house) is unoccupied. Under such conditions, the fire and security system 10 could be armed. If the thermostat 24 programming/schedule indicates operation in an “away” mode, and occupancy is detected or inferred, then the fire and security system 10 can notify the homeowner via the mobile device 18c of a potential intrusion. In addition, if the thermostat 24 programming/schedule indicates operation in an “away” mode, and it can be determined that a mobile phone 18c or user device 60 is not connected or within a selected range of the premises (e.g., geofencing) then such information can be used to notify the homeowner and optionally automatically arm the fire and security system 10. In some embodiments, the fire and security system 10 is armed after a selected duration. It will be appreciated that this would provide a secondary occupancy detection technique if the primary alarm occupancy detection (e.g. sensor 12 of the fire and security system 10) has been defeated. Advantageously, such an approach provides occupancy detection capabilities of one system (e.g. HVAC system 20) acting as a back up to the to the fire and security system 10 detection. Moreover, such configurations provides additional security to a homeowner in cases where they forget to arm the fire and security system 10 when leaving the premises.

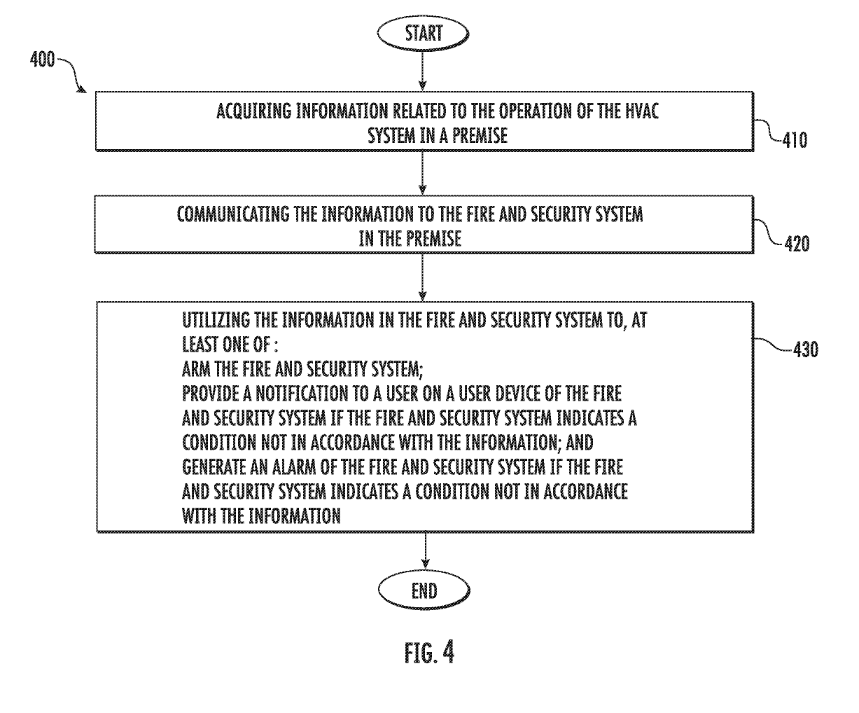

Turning now to FIG. 4 and continuing with FIG. 3, depicting a method 400 of applying information from a heating ventilation and air conditioning (HVAC) system 20 in a premises 11 to a fire and security system 10 in the premises 11. The method 400 is initiated at process step 410 with the acquisition of information related to the operation of the HVAC system 20. In an embodiment, the information could be user settings, operational parameters for the HVAC system 20, sensor data, and the like. The method 400 continues at process step 420 with the information being communicated to a fire and security system 10 in the premises 11. At process step 430, the information communicated from process step 420 is utilized by the fire and security system 10 to conduct various actions. In an embodiment, the information may be employed to arm the fire and security system 10, or provide a notification to a user on a user device (e.g., mobile phone 18c, 60) of the fire and security system 10 if the fire and security system 10 indicates a condition not in accordance with the information. In addition, the information may be used to generate an alarm of the fire and security system 10 if the fire and security system 10 indicates a condition not in accordance with the information.

The technical effects and benefits of embodiments relate to a method and system for applying sensor information, and user scheduling and preferences from a user's HVAC system 20 as an additional, backup or replacement input for an access control and/or security system. More particularly, employing the sensors (e.g., 54), and settings for determining or inferring occupancy associated with the operation of the HVAC system 20 to provide a determination of occupancy of the building space (e.g., a user's home).

The terminology used herein is for the purpose of describing particular embodiments only and is not intended to be limiting of scope and breadth of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the described embodiments in the form disclosed. Many modifications and variations will be apparent to those of ordinary skill in the art without departing from the scope and spirit of the claims. The embodiments have been chosen and described in order to best explain the principles of the inventive concept and the practical application, and to enable others of ordinary skill in the art to understand the scope and breadth of the claims and the various embodiments with various modifications as are suited to the particular use contemplated.

What is claimed is:

1. A method of applying information from a heating ventilation and air conditioning (HVAC) system in a premises to a fire and security system in the premises, the method comprising:
acquiring information related to the operation of the HVAC system;
communicating the information to the fire and security system building system; and
utilizing the information in the fire and security system to perform at least one of:
arm the fire and security system;
provide a notification to a user, on a user device, of the fire and security system if the fire and security system indicates a condition not in accordance with the information; and
generate an alarm, of the fire and security system, if the fire and security system indicates a condition not in accordance with the information.

2. The method of claim 1, wherein the acquiring includes the fire and security system communicating to at least one of a sensor in the HVAC system, a cloud computing environment, the user device, and a control device associated with the HVAC system.

3. The method of claim 1, wherein the information includes at least one of: HVAC system sensor information, a user setting or preference or schedule, and an operational parameter of the HVAC system.

4. The method of claim 3, wherein the information is inferred from the at least one of: user setting or preference, and the operational parameter of the HVAC system.

5. The method of claim 4, wherein the information inferred is the occupancy of the premises based on programming of the HVAC system as “away” from the premises.

6. The method of claim 4, wherein the HVAC system and the fire and security system are separate stand-alone systems.

7. The method of claim 1, wherein the information is used as one of a replacement for sensor information of the fire and security system or in addition to sensor information of the fire and security system.

8. The method of claim 1, wherein the information is occupancy of the premises.

9. The method of claim 1, wherein the information is occupancy and the utilizing is in lieu of a sensor in the fire and security system.

10. The method of claim 1, further including determining if a user device is not connected or within a selected range of the premises to facilitate using the information.

11. A system for applying information from a heating ventilation and air conditioning (HVAC) system in a premises to a fire and security system in the premises, the system comprising:
an HVAC system configured to control the environment of a premises, the HVAC system having a controller; and
a fire and security system configured to monitor the access to a premises, the fire and security system having a controller and a sensor for monitoring activity at the premises, the controller configured to:
acquire information related to the operation of the HVAC system; and
using the information in the fire and security system to at least one of:
arm the fire and security system;
provide a notification to a user, on a user device, of the fire and security system if the fire and security system indicates a condition not in accordance with the information; and
generate an alarm, of the fire and security system, if the fire and security system indicates a condition not in accordance with the information.

12. The system of claim 11, wherein the fire and security system is in operable communication with at least one of a sensor in the HVAC system, a cloud computing environment, the user device, and a control device associated with the HVAC system.

13. The system of claim 11, wherein the information includes at least one of: HVAC system sensor information, a user setting or preference, and an operational parameter of the HVAC system.

14. The system of claim 13, wherein the information is inferred from the at least one of: user setting or preference, and operational parameter of the HVAC system.

15. The system of claim 14, wherein the information inferred is the occupancy of the premises based on programming of the HVAC system as “away” from the premises.

16. The system of claim 14, wherein the HVAC system and the fire and security system are separate stand-alone systems.

17. The system of claim 11, wherein the information is used as one of a replacement for sensor information of the fire and security system or in addition to sensor information of the fire and security system.

18. The system of claim 11, wherein the information is occupancy of the premises.

19. The system of claim 11, wherein the information is occupancy and the controller uses the information in lieu of using a sensor in the fire and security system.

20. The system of claim 11, further including the controller configured to determine if a user device is not connected or within a selected range of the premises to facilitate the using the information.
